(19) United States
(12) Patent Application Publication
(10) Pub. No.: US 2004/0253404 A1
(43) Pub. Date: Dec. 16, 2004

(54) Artificial leather for blocking electromagnetic waves

(75) Inventors: Ching-Tang Wang, Taipei (TW); Mong-Ching Lin, Kaohsiung (TW); Chung-Chih Feng, Kaohsiung (TW); Yuan-Fang Tsai, Fongshan City (TW); Jung-Lung Sun, Kaohsiung (TW)

Correspondence Address: NIKOLAI & MERSEREAU, P.A., 900 SECOND AVENUE SOUTH, SUITE 820, MINNEAPOLIS, MN, 55402, US

(73) Assignee: San Fang Chemical Industry Co., LTD., Kaohsiung (TW)

(21) Appl. No.: 10/847,802

(22) Filed: May 17, 2004

(30) Foreign Application Priority Data
Jun. 16, 2003 (TW) 92116310

(51) Int. Cl. B32B 1/00

(52) U.S. Cl. 428/41.8; 428/328; 428/202; 156/344

(57) ABSTRACT

Artificial leather is provided blocking electromagnetic waves. The artificial leather includes a substrate and a blocking layer provided on the substrate. The blocking layer includes metal mixed with elastomeric resin. The metal is provided in the form of powder. The metal is copper, nickel or silver. The elastomeric resin is polyurethane, polyvinyl chloride, SBR, NBR, polyamide or acrylic.

### FIELD OF INVENTION

The present invention relates to artificial leather for blocking electromagnetic waves.

### BACKGROUND OF INVENTION

As technology advances, people use more and more electronic products such as microwave stoves, electromagnetic stoves and computers in their everyday life and work. While enjoying convenience thanks to the electronic products, people suffer side effects such as electromagnetic waves. It has been shown from long-term investigations that electromagnetic waves are linked to diseases such as brain tumors, leukemia, sterility and miscarriage.

Use of electronic products entails electronic waves. Electronic products must be covered by means of shelters for blocking electromagnetic waves produced by means of the electronic products or people around electronic products must put on garments for blocking electromagnetic waves.

Artificial leather has been made that can block electromagnetic waves. Such artificial leather is produced in various manners. For example, in Taiwanese Patent No. 111213, a first type of such artificial leather is made by means of providing a metal coating on a plastic substrate through vapor deposition. The first type of such artificial leather suffers stripping of the metal coating from the plastic substrate. In Taiwanese Patent No. 040089, a second type of such artificial leather is produced by means of providing a plastic coating on a substrate made of metal fibers. The second type of artificial leather provides an un-desirable rigid feel and suffers raptures of the metal fibers.

The present invention is therefore intended to obviate or at least alleviate the problems encountered in prior art.

### SUMMARY OF INVENTION

It is the primary objective of the present invention to provide flexible yet strong artificial leather for blocking electromagnetic waves.

According to the present invention, artificial leather includes a substrate and a blocking layer provided on the substrate. The blocking layer includes metal mixed elastomeric resin.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a cross-sectional view of artificial leather according to a first embodiment of the present invention.

FIG. 2 is a cross-sectional view of artificial leather according to a second embodiment of the present invention.

FIG. 3 is a cross-sectional view of artificial leather according to a third embodiment of the present invention.

FIG. 4 is a cross-sectional view of artificial leather according to a fourth embodiment of the present invention.

FIG. 5 is a flow chart of a method for producing the artificial leather shown in FIG. 1.

FIG. 6 is a flow chart of a method for producing the artificial leather shown in FIG. 3.

FIG. 7 is a flow chart of a method for producing the artificial leather shown in FIG. 4.

### DETAILED DESCRIPTION OF EMBODIMENTS

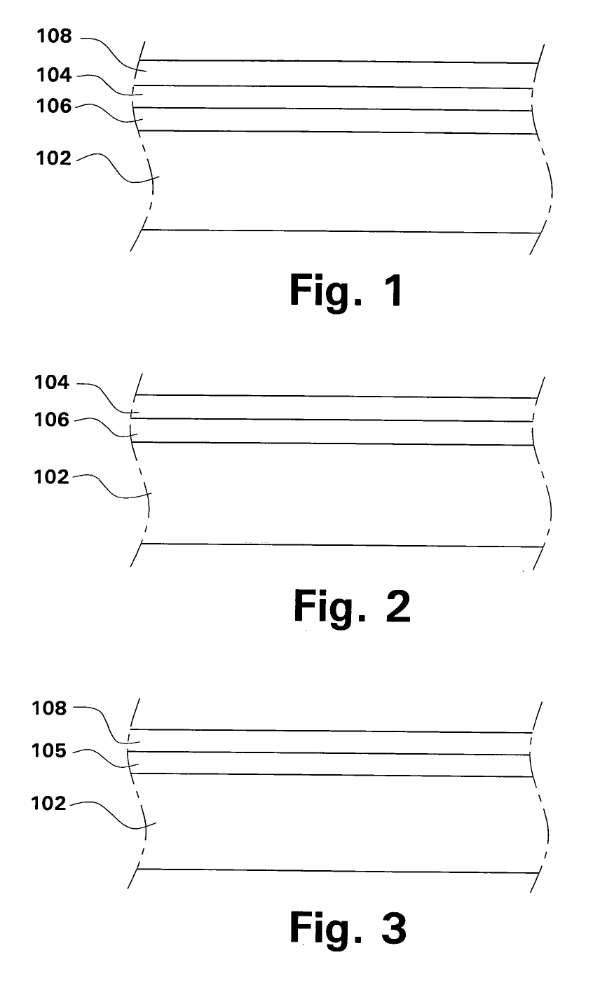

FIG. 1 shows artificial leather according to a first embodiment of the present invention. The artificial leather includes a substrate 102, an adherent layer 106 provided on the substrate 102, a blocking layer 104 provided on the adherent layer 106 and a surfacing layer 108 provided on the blocking layer 104.

The substrate 102 is non-woven cloth or fabric.

The adherent layer 106 is made of elastomeric resin such as polyurethane, polyvinyl chloride, styrene butadiene rubber (“SBR”), nitrile butadiene rubber (“NBR”), polyamide and acrylic, alone or in combination.

The blocking layer 104 is made of elastomeric resin and metal added to the elastomeric resin. The elastomeric resin is polyurethane, polyvinyl chloride, SBR, NBR, polyamide and acrylic, alone or in combination. The elastomeric resin includes a solid content of 30-70%_{wt} and a viscosity of 3000-12000 cps at 30 degrees Celsius. The metal is copper, nickel and silver or any combination of these elements. The metal is provided in the form of powder. The metal make 22.5-52.5%_{wt} of the blocking layer 104. Should the metal make less than 22.5%_{wt} of the blocking layer 104, the blocking layer 104 could hardly block electromagnetic waves. Should the metal make more than 52.5%_{wt} of the blocking layer 104, the blocking layer 104 could hardly be formed.

The surfacing layer 108 is made of elastomeric resin such as polyurethane, polyvinyl chloride, SBR, NBR, polyamide and acrylic, alone or in combination.

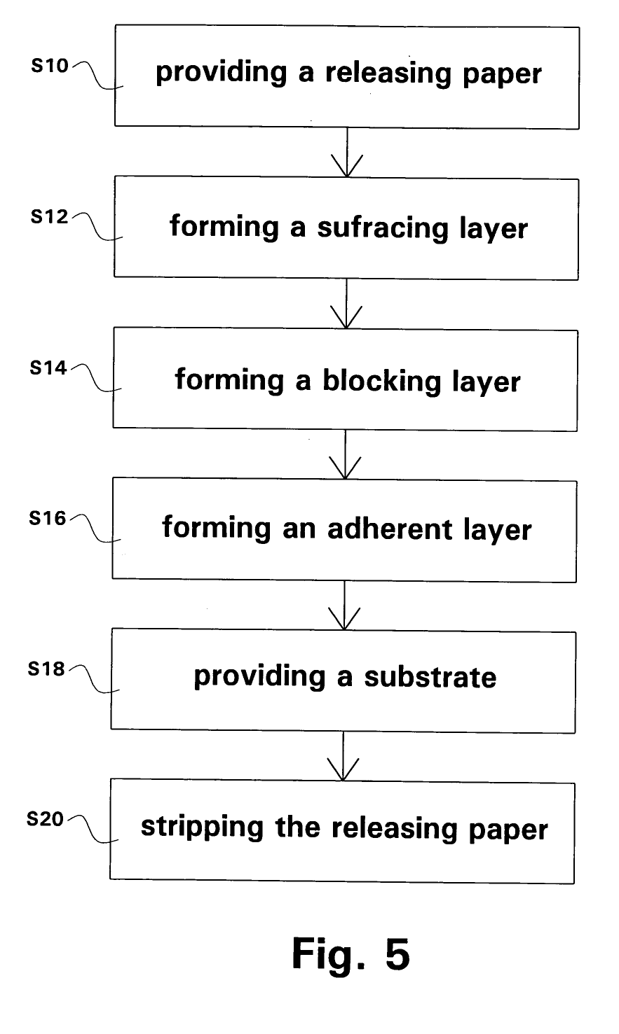

FIG. 5 is a flow chart of a method for producing the artificial leather shown in FIG. 1.

At step S10, releasing paper is provided. The releasing paper is not shown for not being an element of the artificial leather according to the present invention.

At step S12, the surfacing layer 108 is formed. In detail, a first type of elastomeric resin is provided on the releasing paper. The first type of elastomeric resin is subject to a temperature of 80-120 degrees Celsius so that it cures and forms the surfacing layer 108. The layer of elastomeric resin shrinks after curing.

At step S14, the blocking layer 104 is formed. In detail, a second type of elastomeric resin is mixed with metal powder. The mixture of the second type of elastomeric resin with the metal powder is provided on the surfacing layer 108. The mixture of the second type of elastomeric resin with the metal powder is subject to a temperature of 80-120 degrees Celsius so that it cures and forms the blocking layer 104.

At step 16, the adherent layer 106 is formed. In detail, a third type of elastomeric resin is provided on the blocking layer 104.

At step S18, the substrate 102 is provided. The substrate 102 is put on the adherent layer 106. The third type of elastomeric resin is subject to a temperature of 80-120 degrees Celsius so that it cures and forms cross-linked network between the substrate 102 and the blocking layer 104.

At step S20, the releasing paper is stripped from the surfacing layer 108.

FIG. 2 shows artificial leather according to a second embodiment of the present invention. The second embodiment is identical to the first embodiment except for saving the surfacing layer 108.

To produce the artificial leather according to the second embodiment of the present invention, the method shown in FIG. 5 is modified through saving step S12.

FIG. 3 shows artificial leather according to a third embodiment of the present invention. The third embodiment is identical to the first embodiment except for two things. Firstly, the blocking layer 104 is replaced with a adherent blocking layer 105. The adherent blocking layer 105 can adhere to both the surfacing layer 108 and the substrate 102. Secondly, the adherent layer 106 is saved.

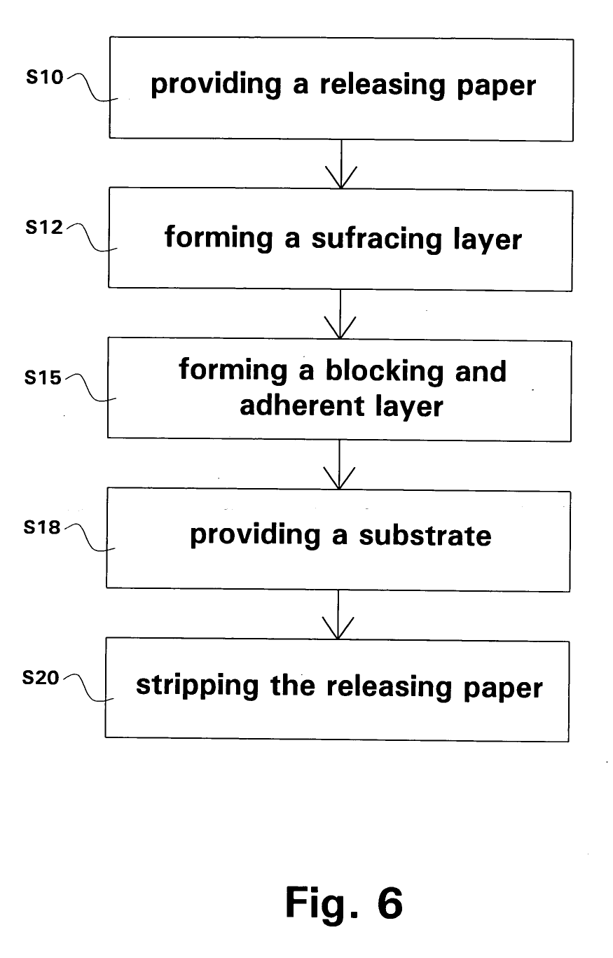

FIG. 6 is a flow chart of a method for producing the artificial leather shown in FIG. 3. The method shown in FIG. 6 is identical to the method shown in FIG. 5 except for two things. Firstly, step S14 is replaced with step S15. Instead of the blocking layer 104 provided at step S104, the adherent blocking layer 105 is provided at step S15. The substrate 102 is put on the adherent blocking layer 105 instead of the adherent layer 106. Secondly, step S16 is saved from the method shown in FIG. 6.

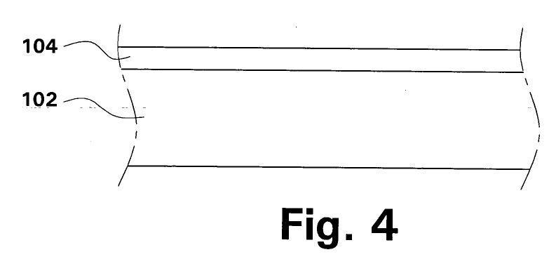

FIG. 4 shows artificial leather according to a fourth embodiment of the present invention. The second embodiment is identical to the third embodiment except for saving the surfacing layer 108.

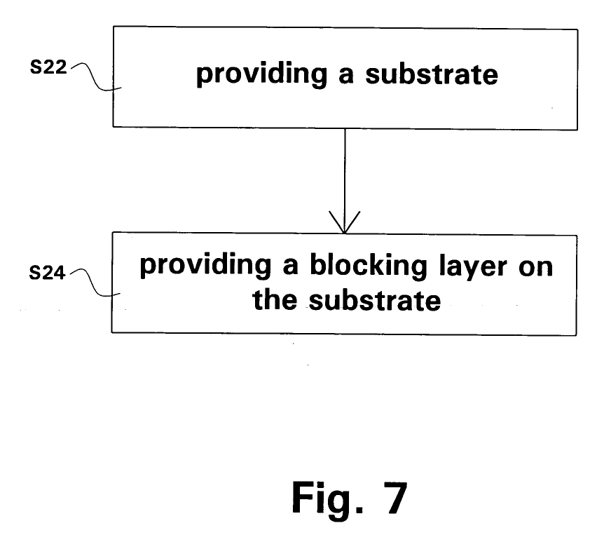

FIG. 7 is a flow chart of a method for producing the artificial leather shown in FIG. 4. At step S22, the substrate 102 is provided. At step S24, the blocking layer 104 is provided on the substrate 102.

To produce the artificial leather according to the second embodiment of the present invention, the method shown in FIG. 6 is modified through saving step S12.

In an embodiment, the first type of elastomeric resin is one-component polyurethane with a solid content of 50%_{wt} and a viscosity of 5000 cps at 30 degrees Celsius. At step S12, the first type of elastomeric resin is subject to a temperature of 105 degrees Celsius. The second type of elastomeric resin is one-component polyurethane with a solid content of 50%_{wt} and a viscosity of 5000 cps at 30 degrees Celsius. The metal includes 65%_{wt} of silver and 35%_{wt} of copper. Silver and copper are both provided in the form of powder of 425 mesh. At step S14, the mixture of the second type of elastomeric resin with the metal powder is subject to a temperature of 105 degrees Celsius. The blocking layer 104 is 0.06 mm thick. The third type of elastomeric resin is duo-component polyurethane. The resultant artificial leather is 0.55 mm thick. It has been found from a research that the resultant artificial leather blocks 98.57% of electromagnetic waves at 300 MHz, 99.95% at 900 MHz, 99.992% at 1800 MHz and 98.008% at 2450 MHz.

The present invention has been described via detailed illustration of some embodiments. Those skilled in the art can derive variations from the embodiments without departing from the scope of the present invention. Therefore, the embodiments shall not limit the scope of the present invention defined in the claims.

1. Artificial leather for blocking electromagnetic waves comprising a blocking layer for blocking electromagnetic wavers, the blocking layer comprising metal mixed with elastomeric resin and thus being electrically conductive.

2. The artificial leather according to claim 1 wherein the weight of the metal is 22.5-52.5%_{wt} of that of the blocking layer.

3. The artificial leather according to claim 1 wherein the metal is provided in the form of powder.

4. The artificial leather according to claim 3 wherein the metal is selected from a group consisting of copper, nickel and silver.

5. The artificial leather according to claim 1 further comprising a substrate, the blocking layer being provided on the substrate, further comprising an adherent layer sandwiched between the substrate and the blocking layer.

6. The artificial leather according to claim 1 comprising a surfacing layer provided on the blocking layer.

7. Artificial leather for blocking electromagnetic waves comprising a substrate, a adherent blocking layer provided on the substrate and a surfacing layer provided on the adherent blocking layer, wherein the blocking layer comprises metal mixed with elastomeric resin.

8. A method for making artificial leather for blocking electromagnetic waves comprising the steps of:
providing releasing paper;
providing a mixture of a type of elastomeric resin with metal;
providing the mixture on the releasing paper so as to form a blocking layer;
providing an adherent type of elastomeric resin on the blocking layer so as to form an adherent layer;
providing a substrate on the adherent layer; and
peeling the releasing paper from the blocking layer.

9. The method according to claim 8 wherein the weight of the metal is 22.5-52.5% of that of the blocking layer.

10. The method according to claim 8 wherein the metal is provided in the form of powder.

11. The method according to claim 10 wherein the metal is selected from a group consisting of copper, nickel and silver.

12. The method according to claim 8 comprising a step of providing another type of elastomeric resin between the releasing paper and the blocking layer so as to form a surfacing layer.

13. A method for making artificial leather for blocking electromagnetic waves comprising the steps of:
providing releasing paper;
providing a type of elastomeric resin on the releasing paper so as to form a surfacing layer;
providing a mixture of an adherent type of elastomeric resin with metal;
providing the mixture on the surfacing layer so as to form a adherent blocking layer;
providing a substrate on the adherent blocking layer; and
peeling the releasing paper from the adherent blocking layer.

14. The method according to claim 13 wherein the weight of the metal is 22.5-52.5% of that of the blocking layer.

15. The method according to claim 13 wherein the metal is provided in the form of powder.

16. The method according to claim 15 wherein the metal is selected from a group consisting of copper, nickel and silver.

17. A method for making artificial leather for blocking electromagnetic waves comprising a step of providing a substrate and a step of providing a blocking layer on the substrate, wherein the blocking layer is made via mixing elastomeric resin with metal.

18. The method according to claim 17 wherein the metal is provided in the form of powder.

19. The method according to claim 18 wherein the metal is selected from a group consisting of copper, nickel and silver.

20. The method according to claim 17 wherein the weight of the metal is 22.5-52.5% of that of the blocking layer.
